(19) United States
(12) Patent Application Publication
(10) Pub. No.: US 2003/0074313 A1
(43) Pub. Date: Apr. 17, 2003

(54) Network-based billing method and system

(76) Inventors: Richard McConnell, Belfast (IE); Peter F. King, Half Moon Bay, CA (US); James Clarke, Banbridge (IE); Denis Murphy, Belfast (IE); Michael Rodgers, Belfast (IE)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 10/206,278

(22) Filed: Jul. 26, 2002

Related U.S. Application Data
(63) Continuation of application No. PCT/IE01/00016, filed on Feb. 5, 2001.

(30) Foreign Application Priority Data
Apr. 13, 2000 (IE) 2000/0289
Feb. 3, 2000 (IE) 2000/0108

(51) Int. Cl. G06F 17/60; G06F 15/173

(52) U.S. Cl. 705/40; 709/238; 709/240

(57) ABSTRACT

A gateway routes signals between a WAP mobile phone and an application on a Web server. The application generates a message for each of a number of events recognized according to the service being provided. These messages are transmitted to the gateway. A billing manager in the gateway directs the messages in real time to a real time mediation device if they relate to a pre-pay service, or alternatively to a billing log for off-line processing. The network operator operating the gateway can thus charge in a manner relating to services provided instead of simply call duration.

This is a continuation of International application no. PCT/IE01/00016 filed under the Patent Cooperation Treaty (PCT) on Feb. 5, 2001, published in English under PCT Article 21(2), which claims priority from Irish patent application no. 2000/0289 filed on Apr. 13, 2000 and Irish patent application no. 2000/0108 filed on Feb. 3, 2000.

### FIELD OF THE INVENTION

At least one embodiment of the present invention relates to billing in a network environment in which server applications communicate with clients via a gateway.

### BACKGROUND

At present, there are quite extensive mechanisms for processing subscriber billing data in telecommunication networks such as mobile (“wireless”) networks. To date, however, such processing has been inflexible and so only generates billing data according to limited parameters, such as time duration of a call. Such an arrangement is described in U.S. Pat. No. 5,873,030, in which local mobile networks connect with a national mobile service platform (MNSP) to provide traffic-related billing data.

### SUMMARY OF THE INVENTION

One aspect of the invention is a method that comprises operating a gateway that routes signals between a client and a network server. The method further comprises receiving at the gateway billing data generated by an application on the server, and processing the billing data in the gateway.

Another aspect of the invention is a method that comprises executing an application hosted on a network server communicating with a client via a gateway. The method further comprises automatically generating billing data relating to a service which the application provides to the client, and automatically transmitting the billing data to the gateway, for processing by the gateway.

Other features of the present invention will be apparent from the accompanying drawings and from the detailed description which follows.

### BRIEF DESCRIPTION OF THE DRAWING

One or more embodiments of the present invention are illustrated by way of example and not limitation in the Figure of the accompanying drawing, which illustrates a schematic representation of a billing data processing method and system.

### DETAILED DESCRIPTION OF THE INVENTION

A network-based billing method and system are described. Note that in this description, references to “one embodiment” or “an embodiment” mean that the feature being referred to is included in at least one embodiment of the present invention. Further, separate references to “one embodiment” or “an embodiment” in this description do not necessarily refer to the same embodiment; however, such embodiments are also not mutually exclusive unless so stated, and except as will be readily apparent to those skilled in the art from the description. For example, a feature, structure, act, etc. described in one embodiment may also be included in other embodiments. Thus, the present invention can include a variety of combinations and/or integrations of the embodiments described herein.

The term “gateway” is used herein to mean any access or routing device between one or more server applications and one or more clients. A gateway may be, for example, a wireless access protocol (WAP) gateway, such that the clients are mobile handsets.

As described in greater detail below, in accordance with the present invention, a gateway routes signals between a WAP mobile phone and an application on a Web server. The application generates a message for each of a number of events recognized according to the service being provided. These messages are transmitted to the gateway. A billing manager in the gateway directs the messages in real time to a real time mediation device if they relate to a pre-pay service, or alternatively to a billing log for off-line processing. The network operator operating the gateway can thus charge in a manner relating to services provided instead of simply call duration.

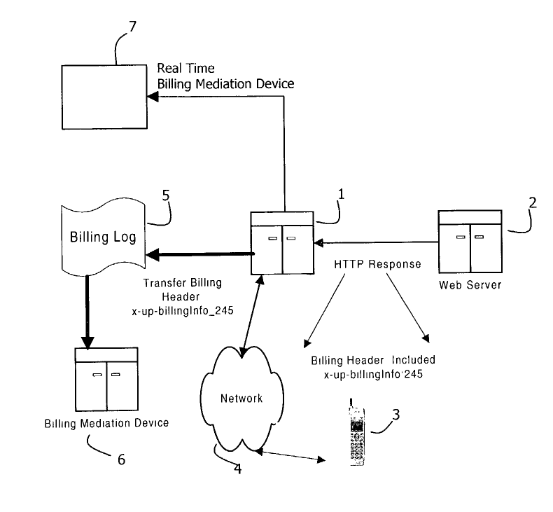

Referring to FIG. 1, there is shown a WAP gateway 1 communicating with a Web (or “origin”) server 2 hosting Web-based applications such as on-line shopping applications. The gateway 1 communicates with mobile handset clients 3 via a mobile network 4. The gateway 1 maintains a billing log 5, and the log 5 is accessed by a billing mediation device 6. The gateway 1 also communicates with a real time billing mediation device 7. The gateway 1 comprises an internal software function called a Billing Manager.

It will be recognized that any or all of the gateway 1, the server 2, and the clients 3, may be implemented using conventional hardware and/or software, such as one or more programmable processors that execute computer program code. The techniques described herein may be implemented at least partially in such computer program code.

An application on the server 2 carries out its operations in conventional manner for processing transactions. However, the application is also programmed to generate messages including a billing-related HTTP header. The header is in a pre-set format, which may be published and used by many Web-based applications on many Web servers. In this embodiment the header has the format “x-up-billing-info:______”. A simple example is “x-up-billing-info:245” to indicate to the gateway 1 that a user (of the client handset 3) has made on-line shopping purchases worth $245 while accessing that application.

The application generates the messages in response to events associated with the service being provided. These events will not all be “billable” and so some messages do not include billing headers.

The gateway 1 detects and extracts each such header. In this embodiment, this is performed by code in the gateway stack recognizing the header. The header is forwarded in real time to the (internal) Billing Manger.

Where the billing data are not required to be processed in real time, the Billing Manager sends the contents of the billing header (together with any others received in the preceding period) to the billing log 5. In this embodiment, the billing log 5 resides on the gateway 1, however, it may instead reside on an external entity. Subsequently, the billing mediation device 6 (which is operated by the mobile network operator) accesses the billing log and uses the data for billing purposes. For example, the mobile network operator may use the data to charge the user or the operator of the application a handling fee of, for example, 1% of the transaction value. Thus, the invention allows parties who are not hosting the application to make charges for service events on an agreed basis with the application host organisation and the user.

In the embodiment described above, the header value is a single numeric value, however, it may be a combination of both text and numerical information and the content of the header may be set according to the particular application.

The Billing Manager may route the billing data to the mediation device 7 in real time. Also, the gateway 1 may transmit the billing data to the client.

In more detail, an event reflects some aspect of the processing of a transaction, and a transaction is a complete request/response cycle from the user's perspective. Each message generated in response to an event contains a number of fields which hold common information, such as source, destination addresses, and data specific to the event itself, such as the URI being retrieved or the volume of data downloaded.

Multiple messages may be created for a single transaction. Each message has a numeric identifier, and all messages that relate to the same transaction are linked with a unique number, called the event linkage id (ELID). The ELID is used to ensure that all messages related to one transaction can be associated, for example during processing by a billing mediation device 6 or 7. The gateway manages the generation and allocation of ELIDs.

The internal components of the gateway (for example processes) also recognize events to mark the progress of a transaction at discrete points, for example, when a response is received from the Web server or when the content has been confirmed to have been received by the client etc. As each event is recognized an associated message is communicated in real-time to the Billing Manager.

The Billing Manager may write the message (or some of its data) to the billing log 5 and/or can send it directly (in real-time) to a real-time billing mediation device 7. The choice of whether to write the message to the billing log or send it via the real-time interface is configurable within the gateway 1. For example, real-time output might be used for prepaid subscribers to allow their available credit to be updated as they perform transactions, while the billing log 5 might be used for post-paid subscribers who are billed periodically. The exhaustion of a pre-pay user's credit would be detected by the real-time billing mediation device, and the configuration of the gateway components would automatically be updated to deny service to that particular subscriber. Subsequently, when the user's credit is re-established the configuration of the gateway would be altered to permit subscriber requests.

Each message is formatted as a Tag-Length-Value (TLV) as described in more detail below. Messages are written to the billing log file in their TLV format. For the real-time interface, a TCP socket connection is established between the Billing Manager and the real-time billing mediation device 7. The Billing Manager outputs the appropriate messages directly onto this connection.

A transaction is generally regarded as a single request and response between the client and the Web server. The transaction may have been initiated either by the client (pull) or by the web server (push). The pull model is used in the following description, but it applies equally to the push model.

A transaction may result in a number of distinct events, each of which is logged separately; the messages of events for a particular transaction have the same ELID, and so all the events for a transaction can be associated. It is the responsibility of the billing mediation device 6 (or some other external system) to reconcile the events for a particular transaction into meaningful billing information for the operator.

While the gateway can track (and record events for) individual transactions between the client and the web server, it has no understanding of the content or value of the service being provided to the user of the client. For example, when accessing a banking application, a user probably has to navigate through a series of menus in order to achieve the service. In a scenario where a user wants to transfer money from one account to the other, an interaction with the web server might be as follows.

1. The user enters his username and secret password to get access to the basic menus

2. The user selects Account Transfer (rather than Balance Enquiry, Checkbook Order, Bill Payment, etc.)

3. The user selects the two accounts for the transfer and the amount to be transferred

4. The application asks the user to confirm the transfer, possibly requesting that the password be re-entered. The success of the transfer is indicated to the user.

5. The user would then sign-off from the application.

This simple service could result in as many as five events, but it is the fourth event that provides the real value for the user and the application provider, i.e. the successful transfer of money from one account to the other. If the user entered the wrong username or password, or unknown account numbers, or the bank was not allowing transfers at this moment in time, transactions would still take place between the client and the web server, but no valuable service has been provided to the user. Similarly, moving £1000 from one account to the other might be considered to have more value than a balance enquiry or ordering a chequebook.

The gateway 1 cannot determine (purely from the transaction) whether a useful service has been provided to the user, or how useful/valuable that service was. Therefore, it would not be possible for the operator to take account of the value of the service provided in billing (or indeed not billing) the user. Only the application (resident on the Web server) can determine in all circumstances whether a service has been provided and the degree of value.

The invention provides a major advance for the network operator as it allows it to enhance its billing strategy and differentiate itself from competitors. The application can include any information it wishes in the billing header, for example the success of the service, the value of the service (e.g. £1000 transferred), the names of the books the user purchased, etc. The format of the information just needs to be agreed between the operator and the application.

The billing header is included in one or more of the event messages created for the transaction. The operator can then consider the information in the billing header when determining whether and how much to bill the user for the service. For example, the operator might choose not to bill the user for any of the transactions unless the user was successfully provided with a service; or the user might be billed a small amount for each transaction, and then an additional fee for successful services; and some services might be premium rate, while others might be lower rates. The operator might enter into an agreement with the application provider where the operator bills the user and provides a portion of the revenue to the application provider. Conversely, the application provider may receive the revenue from the user, for example credit card transaction or account transfer, and have to provide a portion to the operator. In this case, the billing header could allow the operator to track the amount due from the application provider.

Event messages are created in a binary ‘Tag, Length, Value’ (TLV) format. Each message has a numeric identifier, called the Event ID. The table below illustrates some example messages. Also shown is an example list of parameters, which might be included in the message. Every message is separately configurable as to whether or not it is logged to the Billing Manager. A number of parameters are common to every message. They are:

EVENT_ID

DATE_TIME

EVENT_LINKAGE_ID

| Event | | |
|---|---|---|
| ID | Description | Parameters present |
| 3003 | Confirms that a transaction | SOURCE_ADDRESS |
| | response has been received | SOURCE_PORT |
| | by the client. | BEARER_TYPE |
| | | MSISDN |
| | | CLIENT_ID |
| | | PDU_SIZE |
| 3004 | A timeout occurred when waiting | SOURCE_ADDRESS |
| | for a confirmation of a transaction | SOURCE_PORT |
| | response from the client. | BEARER_TYPE |
| 3005 | There has been a WMLScript | SOURCE_ADDRESS |
| | compilation failure. | SOURCE_PORT |
| | | BEARER_TYPE |
| 3010 | There has been a WML encoding | SOURCE_ADDRESS |
| | failure. | SOURCE_PORT |
| | | BEARER_TYPE |
| 3013 | Generated when the network is | SOURCE_ADDRESS |
| | unavailable (e.g. the requested | SOURCE_PORT |
| | site does not exist or a timeout | BEARER_TYPE |
| | occurred trying to connect to | DEST_ADDRESS |
| | the site) | DEST_PORT |
| | | MSISDN |
| | | CLIENT_ID |
| 3014 | An HTTP response has been | SOURCE_ADDRESS |
| | received from the origin server. | SOURCE_PORT |
| | | BEARER_TYPE |
| | | STATUS |
| | | URI |
| | | CONTENT_LENGTH |
| | | MSISDN |
| | | CLIENT_ID |
| | | BILL_HTTP_HEADER** |
| | | BILL_HTTP_VALUE** |
| 3017 | An HTTP request has been | SOURCE_ADDRESS |
| | received from the handset. | SOURCE_PORT |
| | | BEARER_TYPE |
| | | URI |
| | | MSISDN |
| | | CLIENT_ID |
| | | CLASS_OF_INTERFACE |
| | | USER_AGENT_HEADER |
| | | CLASS_OF_SERVICE |

As is clear from the above, only the message for event 3014 has a billing header. Many event messages do not include headers because:

Only the application knows whether a useful service has been provided to the user, and so the application decides the transactions for which to return a billing header. Therefore, the billing header may not have been returned for some transactions and therefore cannot be included in the events resulting from that transaction.

Some events are recognized by the gateway before the web server has returned the response to the request. For example an event might be that a request had been received from the client, or that the request has been forwarded to the Web server. Since no response has yet been received from the Web server, no billing header exists and therefore cannot be included in any events.

The gateway may produce a number of event messages once the response is returned from the Web server. If the billing header was included in the response, it does not need to be included in every event message because:

All events can be associated via the ELID and therefore the billing header only needs to be included in at least one event

On a system with high traffic levels, the processing and storage of unnecessary or redundant data needs to be avoided. For example, it could cause increased use of disk storage space, performance degradation, or unnecessary use of bandwidth on the real-time connection, all of which represent some form of cost for the operator.

All parameters are represented in a binary TLV format. Each parameter is composed of three parts: A numeric tag which identifies the parameter name; a length which represents the length of the value in bytes; and the value itself. These three parts are defined as:

The numeric tag is always represented with two bytes. See below for a table below defining some example tags.

The length is represented with one or more bytes, with the most significant bit in each byte being used to indicate if the next byte is also part of the length. This is known as Extension-Bit format. After reading the first byte, if the most significant bit is set then the next byte is also read. This continues until a byte read does not have the most significant bit set, up to a maximum of 5 bytes. The numbers represented by the least 7 significant bits of each byte are then used to give the total length. An example is:

The number 0x810D would be decoded as:

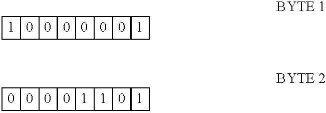

The first byte has the most significant bit set, so a second byte is read. The second byte does not have the most significant bit set, so no more bytes are read. Excluding the most significant bits, the two sets of 7 bits make up a 14 bit number:

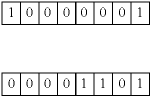

The value of this number is 141 in decimal.

The format of the value itself depends on the type of the tag. Below are some example tags. Each event will use the appropriate set of tags required to represent its parameters.

| Tag | Name | Type | Notes |
|---|---|---|---|
| 0x0006 | STATUS | Integer | The HTTP status code. |
| | | value | |
| 0x0007 | SOURCE_ADDRESS | Dotted | The address is encoded depending on |
| | | quad or | the Bearer type. If the Bearer is |
| | | ASCII text | ANY_ANY_IPV4, |
| | | | then the address is an integer |
| | | | value suitable for an Internet |
| | | | address. If the Bearer is |
| | | | GSM_SMS_GSM_MSISDN, |
| | | | then the address is SMS encoded |
| | | | as ASCII text. |
| 0x0008 | SOURCE_PORT | Integer | Port number which matches the |
| | | value | Source address. |
| 0x0009 | BEARER_TYPE | Integer | Values as defined by WAP. |
| | | value | ANY_ANY_IPV4 = 0, |
| | | | GSM_SMS_GSM_MSISDN = 3. |
| 0x000A | DEST_ADDRESS | Dotted | Encoded in the same way as the |
| | | quad or | Source address. |
| | | ASCII text | |
| 0x000B | DEST_PORT | Integer | Port number which matches the |
| | | value | Destination address. |
| 0x001A | URI | ASCII text | The URI which has been accessed. |
| 0x0024 | EVENT_LINKAGE_ID | Integer | This is the identifier used to |
| | | value | link all events related to a particular |
| | | | transaction together. It is a 32-bit |
| | | | number. |
| 0x002B | EVENT_ID | Integer | This number identifies the event |
| | | value | itself, as defined in the table |
| | | | above. |
| 0x002E | DATE_TIME | Integer | Epoch time when the event was |
| | | value | generated. |
| 0x0032 | CONTENT_LENGTH | Integer | The length of the retrieved content. |
| | | value | |
| 0x0048 | MSISDN | ASCII text | Represents an MSISDN number. |
| 0x004A | BILL_HTTP_HEADER | ASCII text | The name of the in-band billing |
| | | | header (always “x-up-billing-info”). |
| 0x004B | BILL_HTTP_VALUE | ASCII text | The corresponding value for the |
| | | | in-band billing header. |
| 0x0056 | PDU_SIZE | Integer | Size in bytes of the WSP PDU |
| | | value | transmitted over the bearer. |

It will be appreciated that the invention allows for control of billing data in a simple, reliable, and versatile manner. For example, this allows choice of which party obtains the “value-added” benefit for transactions or other application operations. It also allows pre-paid billing functionality by providing data for a subscriber account on a pre-paid billing platform. This may, for example, be used to determine if requested content should be returned to the subscriber. The returned data could also be used to influence other decision-making procedures in the gateway. Because the log entry is made after the client acknowledgement, the user will not be billed if there is a transmission error or if the user cancels.

Thus, to summarize the above, a method of capturing billing data for operation of an application on a network server communicating with a client via a gateway has been described. In one embodiment, the method includes the application automatically generating billing data relating to a service it provides; the application automatically transmitting the billing data to the gateway; and the gateway processing the billing data. The application may transmit the billing data in an event message according to a pre-set format. The message may comprise a HTTP header. The application may generate a message for each activity recognized as an event and transmit the messages to the gateway. The application may recognize a plurality of events for a transaction. The application may include a common event linkage identifier in each event message associated with a particular transaction. The application may recognize a transaction failure and/or a time-out as an event. Each event message may have a unique identifier, which may be a number whereby identifiers of sequential messages are sequential numbers. Each event message may comprise at least one parameter value. Each parameter value may be represented in a tag-length-value format in which a tag field identifies a parameter name, the length field identifies the length of the value in bytes, and the value field contains the parameter value. The gateway may generate billing data according to signal flows between the application and the client and may store the billing data in addition to that originating from the application. The gateway may recognize events according to signal flows between the application and the client and may generate corresponding messages. The gateway may route event messages to a billing log for off-line processing or to a real time mediation device for real time processing according to configuration settings. The gateway further may route event messages to the real time mediation device if the events relate to pre-paid services. Within the gateway, messages may be routed in real time to a billing manager, such that the billing manager processes the messages.

The present invention is not limited to the embodiments described above but may be varied in construction and detail. For example, while the event messages are received and processed by a WAP gateway in the above description, they may alternatively be processed by any routing node between the application and the user device. The term “gateway” is intended to mean any such node or device.

What is claimed is:

1. A method comprising:
operating a gateway that routes signals between a client and a network server;
receiving at the gateway billing data generated by an application on the server; and
processing the billing data in the gateway.

2. A method as recited in claim 1, wherein the client is a mobile client.

3. A method as recited in claim 1, wherein said processing comprises:
classifying the data as requiring real time processing or off-line processing; and
routing the data according to a result of said classifying.

4. A method as recited in claim 3, wherein said routing the data according to a result of said classifying comprises:
routing the data for storage in a log if the data require off-line processing; and
routing the data to a real time mediation device if the data require real time processing.

5. A method as recited in claim 1, wherein the billing data are incorporated in event messages from the application.

6. A method as recited in claim 5, further comprising routing the event messages to a billing log for off-line processing or to a real time mediation device for real time processing according to configuration settings.

7. A method as recited in claim 6, further comprising:
routing event messages to the real time mediation device if the events relate to pre-paid services; and
routing the event messages to a billing log if the data require off-line processing.

8. A method as recited in claim 1, further comprising generating billing data in the gateway according to signal flows between the application and the client, and storing the billing data in addition to the billing data generated by the application.

9. A method as recited in claim 8, further comprising recognizing events in the gateway according to signal flows between the application and the client, and generating corresponding event messages.

10. A gateway to route signals between a network server and a client, the gateway comprising:
a processor; and
a storage medium having stored therein instructions which, when executed by the processor, cause the gateway to perform a method as recited in claim 1.

11. A method of operating a gateway that routes signals between a mobile client and an application hosted on a network server:
receiving at the gateway event messages containing billing data generated by the application and corresponding to events recognized by the application as relating to a billable service the application provides;
classifying the billing data as requiring real time processing or off-line processing;
routing the billing data for storage in a log if the data require off-line processing; and
routing the billing data to a real time mediation device if the billing data require real time processing.

12. A method as recited in claim 11, wherein the billing data is incorporated in event messages.

13. A method as recited in claim 11, further comprising generating event messages in the gateway according to handling of signals for transaction.

14. A method as recited in claim 11, further comprising recognizing events in the gateway according to signal flows between the application and the client, and generating corresponding event messages.

15. A gateway to route signals between a network server and a client, the gateway comprising:
a processor; and
a storage medium having stored therein instructions which, when executed by the processor, cause the gateway to perform a method as recited in claim 11.

16. A method of executing an application hosted on a network server communicating with a client via a gateway, the method comprising:
automatically generating billing data relating to a service which the application provides to the client; and
automatically transmitting the billing data to the gateway, for processing by the gateway.

17. A method as recited in claim 16, wherein the client is a mobile client.

18. A method as recited in claim 16, wherein said transmitting the billing data comprises transmitting the billing data in an event message according to a pre-set format.

19. A method as recited in claim 18, wherein the message comprises an HTTP header.

20. A method as recited in claim 16, further comprising:
recognizing each of one or more activities as an event;
generating an event message for each activity recognized as an event; and
transmitting each said event message to the gateway.

21. A method as recited in claim 20, wherein the application recognizes a transaction failure as an event.

22. A method as recited in claim 20, wherein the application recognizes a time-out as an event.

23. A method as recited in claim 20, further comprising recognizing a plurality of events for a transaction.

24. A method as recited in claim 20, further comprising including a common event linkage identifier in each event message associated with a particular transaction.

25. A method as recited in claim 20, wherein each event message has a unique identifier.

26. A method as recited in claim 25, wherein the identifier is a number such that identifiers of sequential messages are sequential numbers.

27. A method as recited in claim 20, wherein each event message comprises at least one parameter value.

28. A method as recited in claim 27, wherein each parameter value is represented in a tag-length-value format in which a tag field identifies a parameter name, the length field identifies the length of the value in bytes, and the value field contains the parameter value.

29. A network server hosting an application which provides a service to a client, the network server comprising:
a processor; and
a storage medium having stored therein instructions which, when executed by the processor, cause the network server to perform a method as recited in claim 20.

30. A method of executing an application hosted on a network server communicating with a mobile client via a gateway, the method comprising:
recognizing each of one or more activities as an event corresponding to a billable service the application provides to the mobile client;
generating an event message representing billing data for each activity recognized as an event; and
transmitting each said event message to the gateway, for processing by the gateway.

31. A method as recited in claim 30, wherein said transmitting each said event message comprises transmitting an event message according to a pre-set format.

32. A method as recited in claim 31, wherein the event message comprises an HTTP header.

33. A method as recited in claim 30, wherein said recognizing comprises recognizing a transaction failure as an event.

34. A method as recited in claim 30, wherein said recognizing comprises recognizing a time-out as an event.

35. A method as recited in claim 30, wherein said recognizing comprises recognizing a plurality of events for a transaction.

36. A method as recited in claim 30, further comprising including a common event linkage identifier in each event message associated with a particular transaction.

37. A method as recited in claim 30, wherein each event message has a unique identifier.

38. A method as recited in claim 37, wherein the identifier is a number such that identifiers of sequential messages are sequential numbers.

39. A method as recited in claim 30, wherein each event message comprises at least one parameter value.

40. A method as recited in claim 39, wherein each parameter value is represented in a tag-length-value format in which a tag field identifies a parameter name, the length field identifies the length of the value in bytes, and the value field contains the parameter value.

41. A network server hosting an application which provides a service to a client, the network server comprising:
a processor; and
a storage medium having stored therein instructions which, when executed by the processor, cause the network server to perform a method as recited in claim 30.

42. A gateway for routing of signals between a client and an application hosted on a network server for performance of a transaction, the gateway comprising:
means for receiving billing data from the application, said billing data relating to a service provided by the application; and
means for processing the billing data.

43. A gateway as recited in claim 42, wherein the means for processing comprises means for classifying the data as requiring real time processing or off-line processing and for routing the data according to an outcome of said classifying.

44. A gateway as recited in claim 43, wherein the billing data is incorporated in event messages.

45. A gateway as recited in claim 42, further comprising:
a billing manager;
means for routing billing data in real time to the billing manager; and
means for directing storage of the data in a log for off-line processing or for routing the data to a real time mediation device for real time processing.

46. A billing system comprising:
a gateway to route signals between a client and an application hosted on a network server for performance of a transaction, the gateway further to receive billing data from the application, said billing data relating to a service provided by the application to the client, and to process the billing data by classifying the billing data as requiring real time processing or off-line processing and routing the billing data according to an outcome of said classifying;
a first mediation device to read billing data in a billing log which is updated by the gateway and to process the billing data; and
a second mediation device to perform real time processing of billing data received from the gateway.
